(19) United States
(12) Patent Application Publication
(10) Pub. No.: US 2022/0076645 A1
(43) Pub. Date: Mar. 10, 2022

(54) PIXEL DRIVING CIRCUIT, PIXEL DRIVING METHOD, ARRAY SUBSTRATE AND DISPLAY DEVICE

(71) Applicants: Hefei Xinsheng Optoelectronics Technology Co., Ltd., Hefei (CN); BOE Technology Group Co., Ltd., Beijing (CN)

(72) Inventors: Bingbing YAN, Beijing (CN); Ke DAI, Beijing (CN); Liugang ZHOU, Beijing (CN); Chunyang NIE, Beijing (CN)

(21) Appl. No.: 17/459,975

(22) Filed: Aug. 27, 2021

(30) Foreign Application Priority Data
Sep. 10, 2020 (CN) 202010945756.9

(51) Int. Cl. G09G 3/36

(52) U.S. Cl. CPC G09G 3/3618; G02F 1/1368; G09G 3/3614; G09G 3/3648

(57) ABSTRACT

A pixel driving circuit, a pixel driving method, an array substrate and a display device are provided. The pixel driving circuit includes a plurality of pixel regions; a pixel electrode array; and a thin film transistor switch, where at least one thin film transistor switch is arranged in each pixel region; the polarities of input voltage signals to two adjacent pixel electrodes are opposite in a same row of pixel electrodes; M rows of pixel electrodes are divided into Q pixel groups, including a first pixel group, a second pixel group and (Q−2) third pixel groups located between the first pixel group and the second pixel group, and each third pixel group includes at least q rows of pixel electrodes; and in the same column of pixel electrodes, the polarities of input voltage signals to the pixel electrodes in the same pixel group are the same, and the polarities of input voltage signals to the pixel electrodes of two adjacent pixel groups are opposite.

### CROSS-REFERENCE TO RELATED APPLICATIONS

This application claims priority to Chinese Patent Application No. 202010945756.9 filed in China on Sep. 10, 2020, the entire contents of which are incorporated herein by reference.

### TECHNICAL FIELD

The invention relates to the technical field of display, in particular to a pixel driving circuit, a pixel driving method, an array substrate and a display device.

### BACKGROUND

The display device with ultra-high clarity and high refresh rate in display market has become the technical development trend of enterprises. Especially for high-end large-size display panels, the refresh frequency is also gradually shifted to 120 Hz. However, typically large size display products, such as TV products, whose pixel architecture supports only one frame rate, such as only 60 Hz or only 120 Hz, cannot be switched in real time between frame rates 60 Hz and 120 Hz.

### SUMMARY

The embodiment of the present disclosure provides a pixel driving circuit, including:

a plurality of gate lines and a plurality of data lines, where the plurality of gate lines and the plurality of data lines are arranged in a crossing manner to define a plurality of pixel regions arranged in an array;

a plurality of pixel electrodes, where one pixel electrode is arranged in each pixel region to form an M×N pixel electrode array, M is the number of rows of the pixel electrode array, N is the number of columns of the pixel electrode array, M and N are integers greater than 1, the row direction of the pixel electrode array is the extension direction of the gate line, and the column direction is the extension direction of the data line:

a thin film transistor switch, where at least one thin film transistor switch is arranged in each pixel region, and the pixel electrode is connected to the data line by the thin film transistor switch and configured to input a voltage signal to the pixel electrode by the data line:

the polarities of input voltage signals to two adjacent pixel electrodes are opposite in a same row of pixel electrodes;

M rows of pixel electrodes are divided into Q pixel groups, including a first pixel group, a second pixel group and (Q−2) third pixel groups located between the first pixel group and the second pixel group, where the first pixel group at least includes a first row of pixel electrodes of the pixel electrode array, and the second pixel group at least includes an NI row of pixel electrodes of the pixel electrode array; and each third pixel group includes at least q rows of pixel electrodes, Q is a positive integer greater than 2, and q is a positive integer greater than or equal to 2:

where in the same column of pixel electrodes, the polarities of input voltage signals to the pixel electrodes in the same pixel group are the same, and the polarities of input voltage signals to the pixel electrodes of two adjacent pixel groups are opposite.

Optionally, the first pixel group includes the first row of pixel electrodes, or the first pixel group includes the first row of pixel electrodes and the (q−1) row of pixel electrodes adjacent to the first row of pixel electrodes.

Optionally, the polarities of input voltage signals to two adjacent data lines are opposite.

in the nth column pixel electrode, all the pixel electrodes of one pixel group of any two adjacent pixel groups are connected to an n^{th} data line, all the pixel electrodes of the other pixel group are connected to an (n+1)^{th} data line, and n is a positive integer less than or equal to N.

Optionally, the pixel driving circuit further includes:

a time sequence controller connected with the gate line and configured to drive the pixel electrode array row by row at a first frame rate in a first time period; and driving the pixel electrode array one pixel group by one pixel group at a second frame rate, where the second frame rate is greater than the first frame rate.

Optionally, the second frame rate is q times the first frame rate.

Optionally, q is equal to 2.

Optionally, the first frame rate is 60 Hz, and the second frame rate is 120 Hz.

Optionally, the second pixel group includes the M^{th} row of pixel electrodes, or the second pixel group includes the M^{th} row of pixel electrodes and the (q−1) row of pixel electrodes adjacent to the M^{th} row of pixel electrodes.

Optionally, the first pixel group includes the first row of pixel electrodes, or the first pixel group includes the first row of pixel electrodes and the (q−1) row of pixel electrodes adjacent to the first row of pixel electrodes.

the second pixel group includes the M^{th} row of pixel electrodes, or the second pixel group includes the M^{th} row of pixel electrodes and the (q−1) row of pixel electrodes adjacent to the M^{th} row of pixel electrodes.

The embodiment of the present disclosure also provides an array substrate including a pixel driving circuit,

where the pixel driving circuit includes:

a plurality of gate lines and a plurality of data lines, where the plurality of gate lines and the plurality of data lines are arranged in a crossing manner to define a plurality of pixel regions arranged in an array;

a plurality of pixel electrodes, where one pixel electrode is arranged in each pixel region to form an M×N pixel electrode array. M is the number of rows of the pixel electrode array, N is the number of columns of the pixel electrode array, M and N are integers greater than 1, the row direction of the pixel electrode array is the extension direction of the gate line, and the column direction is the extension direction of the data line:

a thin film transistor switch, where at least one thin film transistor switch is arranged in each pixel region, and the pixel electrode is connected to the data line by the thin film transistor switch and configured to input a voltage signal to the pixel electrode by the data line;

where, the polarities of input voltage signals to two adjacent pixel electrodes are opposite in a same row of pixel electrodes:

M rows of pixel electrodes are divided into Q pixel groups, including a first pixel group, a second pixel group and (Q−2) third pixel groups located between the first pixel group and the second pixel group, where the first pixel group at least includes a first row of pixel electrodes of the pixel electrode array, and the second pixel group at least includes an M^{th} row of pixel electrodes of the pixel electrode array; and each third pixel group includes at least q rows of pixel electrodes, Q is a positive integer greater than 2, and q is a positive integer greater than or equal to 2:

where in the same column of pixel electrodes, the polarities of input voltage signals to the pixel electrodes in the same pixel group are the same, and the polarities of input voltage signals to the pixel electrodes of two adjacent pixel groups are opposite.

Optionally, the first pixel group includes the first row of pixel electrodes, or the first pixel group includes the first row of pixel electrodes and the (q−1) row of pixel electrodes adjacent to the first row of pixel electrodes; and/or

the second pixel group includes the M^{th} row of pixel electrodes, or the second pixel group includes the M^{th} row of pixel electrodes and the (q−1) row of pixel electrodes adjacent to the M^{th} row of pixel electrodes.

Optionally, the polarities of input voltage signals to two adjacent data lines are opposite.

in the nth column pixel electrode, all the pixel electrodes of one pixel group of any two adjacent pixel groups are connected to an n^{th} data line, all the pixel electrodes of the other pixel group are connected to an (n+1)^{th} data line, and n is a positive integer less than or equal to N.

Optionally, the pixel driving circuit further includes:

a time sequence controller connected with the gate line and configured to drive the pixel electrode array row by row at a first frame rate in a first time period; and driving the pixel electrode array one pixel group by one pixel group at a second frame rate, where the second frame rate is greater than the first frame rate.

Optionally, the second frame rate is q times the first frame rate.

Optionally, q is equal to 2.

Optionally, the first frame rate is 60 Hz, and the second frame rate is 120 Hz.

Optionally, the second pixel group includes the M^{th} row of pixel electrodes, or the second pixel group includes the M^{th} row of pixel electrodes and the (q−1) row of pixel electrodes adjacent to the M^{th} row of pixel electrodes.

Optionally, the first pixel group includes the first row of pixel electrodes, or the first pixel group includes the first row of pixel electrodes and the (q−1) row of pixel electrodes adjacent to the first row of pixel electrodes.

the second pixel group includes the M^{th} row of pixel electrodes, or the second pixel group includes the M^{th} row of pixel electrodes and the (q−1) row of pixel electrodes adjacent to the M^{th} row of pixel electrodes.

The embodiment of the present disclosure also provides a display device including the array substrate as described above.

The embodiment of the invention also provides a pixel driving method, which is applied to the pixel driving circuit.

driving the pixel electrode array row by row at a first frame rate in a first time period; and

driving the pixel electrode array one pixel group by one pixel group at a second frame rate in a second time period, where the second frame rate is greater than the first frame rate.

### BRIEF DESCRIPTION OF THE DRAWINGS

FIG. 1 shows a schematic diagram of a related art pixel driving circuit;

FIG. 2 illustrates a schematic block diagram of an exemplary embodiment of a pixel driving circuit provided by the present disclosure:

FIG. 3 is a schematic diagram illustrating the structure of another exemplary embodiment of a pixel driving circuit provided by the present disclosure;

FIG. 4 shows a first frame rate time sequence waveform output by a time sequence controller in a pixel driving circuit provided by the present disclosure; and

FIG. 5 shows a second frame rate timing waveform output by a timing controller in a pixel driving circuit provided by the present disclosure.

### DETAILED DESCRIPTION

For purposes of clarity, technical solutions and advantages of the disclosed embodiments, reference is made to the accompanying drawings that form a part hereof, and in which is shown by way of illustration specific embodiments in which the invention may be practiced. It is to be understood that the described embodiments are some, but not all, embodiments of the present disclosure. Based on the described embodiments of the present disclosure, all other embodiments obtained by one of ordinary skill in the art are within the scope of the present disclosure.

In describing the present disclosure, it should be noted that the terms “center, upper, lower, left, right, vertical, horizontal, inner, outer”, and the like, indicate orientations or positional relationships that are based on the orientations or positional relationships shown in the drawings, merely to facilitate describing the present disclosure and to simplify the description. Rather than indicate or imply that the referenced devices or elements must have a particular orientation, be constructed and operated in a particular orientation, and thus should not be construed as limiting the present disclosure. Furthermore, the terms “first, second, third” are used for descriptive purposes only and are not to be construed as indicating or implying relative importance.

Before describing in detail the pixel driving circuit and the pixel driving method, the array substrate, and the display device provided by the embodiments of the present disclosure, it is necessary to describe the related art as follows.

Among the related technologies, a display device displaying an ultra-high-definition market and a high refresh rate has become a technical development trend of enterprises. Especially for high-end large-size display panels, the refresh frequency is also gradually shifted to 120 Hz. However, typically large size display products, such as TV products, whose pixel architecture supports only one frame rate, such as only 60 Hz or only 120 Hz, cannot be switched in real time between frame rates 60 Hz and 120 Hz. Especially for the 8K display products, the technical difficulty and cost of realizing the frame rate of 120 Hz are much larger than that of the conventional frame rate of 60 Hz.

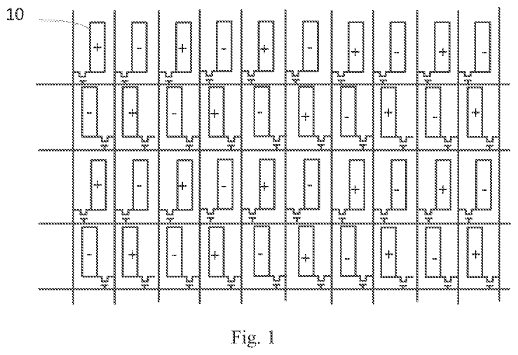

At present, a pixel architecture generally adopts a Z pixel architecture, and FIG. 1 shows a structure schematic diagram of a related art Z pixel architecture, where the Z pixel architecture includes pixel electrodes 10 distributed in an array, input voltage signals to two adjacent pixel electrodes in the same row of pixel electrodes are opposite in polarity, and input voltage signals to two adjacent row of pixel electrodes in the same column of pixel electrodes are opposite in polarity. The Z pixel architecture has the characteristic of excellent picture quality, because more and more display products adopt the Z pixel architecture, but the Z pixel architecture in the related art cannot meet the real-time switching of the frame rate.

In order to solve the technical problem, the pixel driving circuit, the pixel driving method, the array substrate and the display device provided by the embodiment of the invention can realize real-time switching between different frame rates.

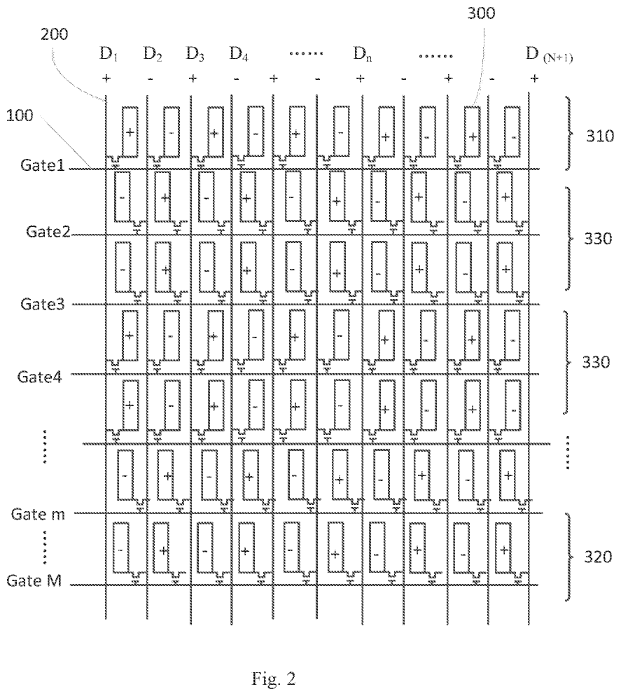

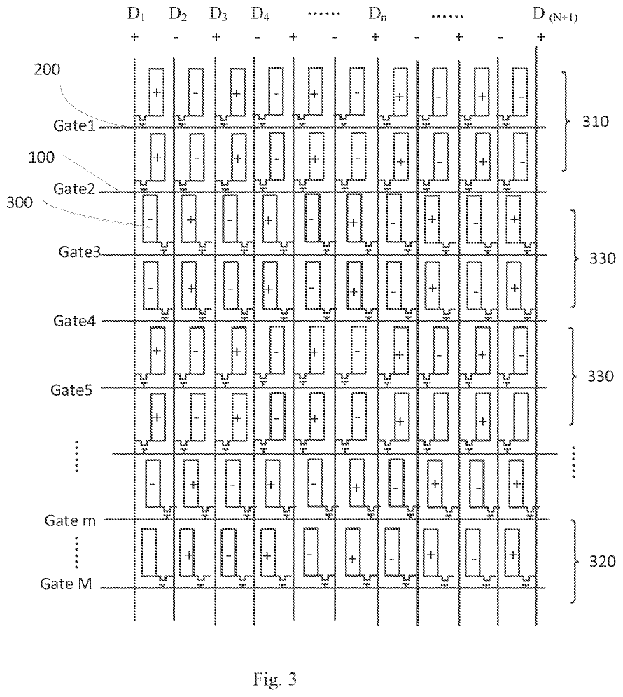

As shown in FIGS. 2 and 3, the pixel driving circuit provided by the embodiment of the present disclosure includes:

A plurality of gate lines 100 and a plurality of data lines 200, the plurality of gate lines 100 and the plurality of data lines 200 being arranged crosswise to define a plurality of pixel regions arranged in an array;

A plurality of pixel electrodes 300, where one pixel electrode 300 is arranged in each pixel region to form an M×N pixel electrode array, M is the number of rows of the pixel electrode array, N is the number of columns of the pixel electrode array, M and N are integers greater than 1, and the row direction of the pixel electrode array is the extending direction of the gate line 100; the column direction is the extending direction of the data line 200;

At least one thin film transistor switch 400 is arranged in each pixel region, and the pixel electrode 300 is connected to the data line 200 through the thin film transistor switch 400 and is configured to input a voltage signal to the pixel electrode 300 through the data line 200:

In the same row of pixel electrodes 300, the polarities of input voltage signals to two adjacent pixel electrodes 300 are opposite;

M rows of pixel electrodes 300 are divided into Q pixel groups, including a first pixel group 310 including at least a first row of pixel electrodes 300 of the pixel electrode array, a second pixel group 320, and (Q−2) third pixel groups 330 located between the first pixel group 310 and the second pixel group 320, the second pixel group 320 at least includes an M^{th} row of pixel electrodes 300 of the pixel electrode array, each third pixel group 330 includes at least q rows of pixel electrodes 300, Q is a positive integer greater than 2, and q is a positive integer greater than or equal to 2;

In the same column of pixel electrodes 300, the polarities of input voltage signals to the pixel electrodes 300 in the same pixel group are the same, and the polarities of input voltage signals to the pixel electrodes 300 in two adjacent pixel groups are opposite.

The pixel driving circuit includes an M×N pixel electrode array, where the polarities of input voltage signals to two adjacent pixel electrodes 300 in the same row of pixel electrodes 30) are opposite, that is, the pixel architecture adopts a column inversion (Coluqn inversion) mode and has the advantage of low power consumption: meanwhile, the M rows of the pixel electrodes 300 are divided into Q pixel groups, in the same column of the pixel electrodes 300, the polarity of voltage signals input to the pixel electrodes 300 in the same pixel group is the same, and the polarity of voltage signals input to the pixel electrodes 300 in adjacent two pixel groups is opposite. In this way, when a scanning signal is input to the gate line 100 through the timing controller during pixel driving, each row of pixel electrodes 300 can be opened row by row at a first frame rate, or the pixel electrode array can be opened pixel by pixel group at a second frame rate, thereby realizing real-time switching between the first frame rate and the second frame rate.

Therefore, the pixel driving circuit provided by the embodiment of the invention is improved based on the Z pixel architecture, has the characteristic of maintaining excellent picture quality, has the power-saving effect of a column overturning mode, and can switch between the first frame rate and the second frame rate in real time according to different picture requirements, so that the video is smoother. For example, the first frame rate (e.g., 60 Hz) is less than the second frame rate (e.g., 120 Hz), the first frame rate is used for normal pictures, and the second frame rate is used for high-speed pictures, so that the video is smoother.

It should be noted that in the above-described embodiment, the number of rows and the number of columns of the pixel electrode array are M and N. and for convenience of description, as shown in FIGS. 2 and 3, in the extending direction of the data line 200, from one end to the other end of the data line 200, M rows of pixel electrodes 300 may be sequentially arranged in M rows numbered 1, 2, 3 . . . m . . . . That is, the M rows of pixel electrodes 300 are a first row of pixel electrodes, a second row of pixel electrodes, a third row of pixel electrodes . . . an m row of pixel electrodes . . . an M row of pixel electrodes, respectively, and m is a positive integer smaller than M; the first row of pixel electrodes and the M row of pixel electrodes are two outermost rows of pixel electrodes in the pixel electrode array; accordingly, taking as an example that each row of pixels has a gate line 100 on each of two opposite sides (in other embodiments, each row of pixels may also have a plurality of gate lines 100 on each of two opposite sides, and the corresponding arrangement serial numbers of the plurality of gate lines 100 are a first gate line (Gate 1) and a second gate line (Gate 2), a third gate line (Gate 3) . . . an m-th gate line (Gate m) . . . an M-th gate line (Gate M), where the first gate line (Gate 1) and the M-th gate line (Gate M) are two outermost gate lines of the plurality of gate lines 100.

Also, in the extending direction of the gate line 100, from one end to the other end of the gate line 10, the N columns of pixel electrodes 300 may be sequentially arranged in rows 1, 2, 3 . . . n . . . , that is, the N rows of pixel electrodes 300 are a first column of pixel electrodes and a second column of pixel electrodes, respectively, a third column pixel electrode . . . and an nth column pixel electrode . . . , where n is a positive integer less than or equal to N, and the first column pixel electrode and the Nth column pixel electrode are two outermost column pixel electrodes in the pixel electrode array; accordingly, taking as an example that each side of each column of pixels opposite to two sides is respectively provided with one data line 200 (in other embodiments, each side of each column of pixels opposite to two sides may also be provided with a plurality of data lines 200), the arrangement serial numbers corresponding to the plurality of data lines 200 are the first data line (D₁), the second data line (D₂) and the third data line According to a line (D₃) . . . n^{th} data line (Dₙ) . . . N^{th} data line (D_{N}) and a (N+1)^{th} data line (D_{(N+1)}), where the first data line and the (N+1)^{th} data line are two outermost data lines in the plurality of data lines.

Note that since a portion of the pixel electrode 300 of the Z pixel architecture is connected to the data line 200 on the left side of the pixel region and another portion of the pixel electrode 300 is connected to the data line 200 on the right side of the pixel region, the number of the data lines 200 is one more than the number N of columns of the pixel electrode 300.

In some alternative embodiments of the present disclosure, the pixel architecture described above may be implemented by: as shown in FIGS. 2 and 3, the polarities of input voltage signals to two adjacent data lines 200 are opposite; in the nth column pixel electrode 300, the pixel electrode 300 of one pixel group of any two adjacent pixel groups is connected to the nth data line 200, the pixel electrode 300 of the other pixel group is connected to the (n+1)^{th} data line 200, and n is a positive integer less than or equal to N.

Therefore, the polarity of the voltage signals input to the same data line 200 is consistent, and the polarity of the voltage signals is positive or negative; in the nth column pixel electrode 300, the pixel electrode 300 of one of any two adjacent pixel groups is connected to the nth data line 200, the pixel electrode 300 of the other pixel group is connected to the (n+1)-th data line 200, and n is a positive integer less than or equal to N, for example, as shown in the figure, for the first column pixel electrode 300, Each row of pixel electrodes 300 in the first pixel group 310 Each row of pixel electrodes 300 in the first third pixel group 330 adjacent to the first pixel group 310 is connected to the second data line 200, and each row of pixel electrodes 300 in the second third pixel group 330 adjacent to the first third pixel group 330 is connected to the first data line 200 and sequentially circulates; finally, the column overturning structure of the pixel driving circuit is realized.

It will of course be appreciated that the above is but one embodiment and that in practice column inversion may be achieved in other ways, for example by providing two data lines 200 of opposite polarity of voltage signals to the same side of any column of pixels, the pixel electrodes 300 of adjacent two pixel groups being connected to data lines 200 of opposite polarity of different voltage signals, respectively.

In addition, in the pixel driving circuit provided by the embodiment of the present disclosure, the M rows of pixel electrodes 300 are divided into Q pixel groups, the first pixel group 310 in the Q pixel groups includes at least the first row of pixel electrodes 300, the second pixel group 320 includes at least the M row of pixel electrodes 300, and the third pixel group 330 is located between the first pixel group 310 and the second pixel group 320. The number of the third pixel group 330 is Q−2, that is, the number of Q pixel groups after removing the first pixel group 310 and the second pixel group 320, and Q−2 should be greater than 2. The particular division of the Q pixel groups may be varied, as described optionally below.

For example, in some embodiments, as shown in FIG. 2, the number of rows of pixel electrodes 300 included in the first pixel group 310 may be one, i.e., the first pixel group 310 includes a first row of pixel electrodes 300. Taking q equal to 2, that is, a third pixel group 330 including 2 rows of pixel electrodes 300 as an example, the first pixel group 310 may include a first row of pixel electrodes 300. At this time, the number of rows of pixel electrodes 300 included in the second pixel group 320 may also be 1, that is, the second pixel group 320 also includes an M^{th} row of pixel electrodes 300; alternatively, the number of rows of pixel electrodes 300 included in the second pixel group 320 may be q, that is, the number of rows of pixel electrodes 300 in the second pixel group 320 is the same as the number of rows of pixel electrodes 300 in the third pixel group 330, and the second pixel group 320 includes the M^{th} row of pixel electrodes 300 and (q−1) row of pixel electrodes 300 adjacent to the M^{th} row of pixel electrodes 300.

For example, in other embodiments, as shown in FIG. 3, the number of rows of pixel electrodes 300 included in the first pixel group 310 may be q, i.e., the number of rows of pixel electrodes 300 in the first pixel group 310 is the same as the number of rows of pixel electrodes 300 in the third pixel group 330. The first pixel group 310 may include a first row of pixel electrodes 300 and a (q−1) row pixel electrode 300 adjacent to the first row of pixel electrodes 300. Taking q equal to two as an example, the third pixel group 330 includes two rows of pixel electrodes 300, and the first pixel group 310 also includes two rows of pixel electrodes 300. At this time, the number of rows of pixel electrodes 300 included in the second pixel group 320 may be 1, that is, the second pixel group 320 also includes an M^{th} row of pixel electrodes 300; alternatively, the number of rows of pixel electrodes 300 included in the second pixel group 320 may be q, that is, the number of rows of pixel electrodes 300 in the second pixel group 320 is the same as the number of rows of pixel electrodes 300 in the third pixel group 330, and the second pixel group 320 includes the M^{th} row of pixel electrodes 300 and (q−1) row of pixel electrodes 300 adjacent to the M^{th} row of pixel electrodes 300.

In addition, in the disclosed embodiment, the pixel driving circuit further includes: a time sequence controller (TCON) connected to the gate line 100 and configured to drive the pixel electrode array row by row at a first time period at a first frame rate; and driving the pixel electrode array one pixel group by one pixel group at a second frame rate, where the second frame rate is greater than the first frame rate.

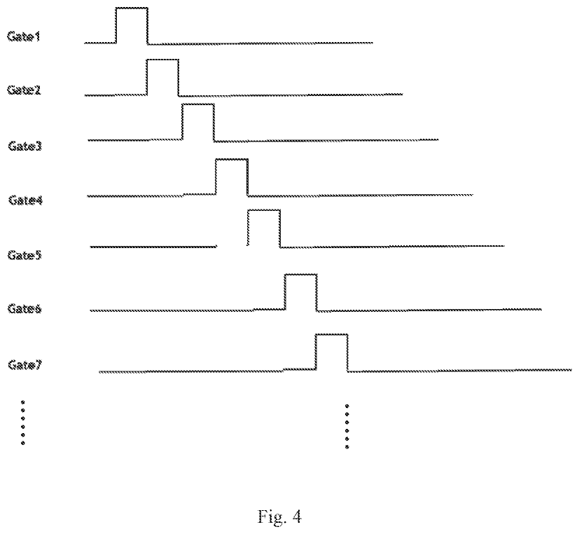

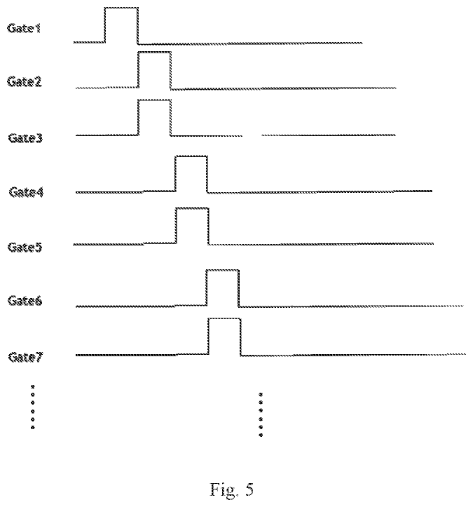

According to the scheme, the real-time switching between the first frame rate and the second frame rate is realized by adjusting the time sequence of the time sequence controller, when the first frame rate is output, the gate line 100 is opened line by line, and the time sequence waveform is shown in FIG. 4; when the second frame rate is output, the pixel groups are turned on one by one in units of the pixel groups, that is, the pixel electrodes 300 of each row in the same pixel group are turned on at the same time, and the timing waveform diagram thereof is shown in FIG. 5.

Note that since the number of rows of the pixel electrodes 300 in the third pixel group 330 is q, q rows of the pixel electrodes 300 in the same pixel group are opened simultaneously at the second frame rate, and the pixel electrodes 300 are opened one by one at the first frame rate, the second frame rate may be q times the first frame rate. Optionally, q is equal to 2.

Optionally, the first frame rate is 60 Hz, and the second frame rate is 120 Hz. It will of course be appreciated that the first frame rate and the second frame rate may or may not be limited in practice.

According to the pixel driving circuit of the embodiment of the disclosure, the pixel driving circuit includes an M N pixel electrode array, where the polarities of input voltage signals to two adjacent pixel electrodes in the same row of pixel electrodes are opposite, the M row of pixel electrodes are divided into Q pixel groups, and in the same column of pixel electrodes, the polarities of input voltage signals to the pixel electrodes in the same pixel group are the same, and the polarity of the input voltage signals to the pixel electrodes of two adjacent pixel groups is opposite. Therefore, during pixel driving, a scanning signal can be input to the gate line through the time sequence controller, each row of pixel electrodes can be opened row by row at a first frame rate, or the pixel electrode array can be opened pixel by pixel group at a second frame rate, so that real-time switching between the first frame rate and the second frame rate is realized. The pixel structure of the pixel driving circuit keeps the characteristic of excellent picture quality, has the power-saving effect of a column overturning mode, can switch between the first frame rate and the second frame rate in real time according to different picture requirements, and enables video to be smoother.

In addition, the embodiment of the disclosure also provides an array substrate including the pixel driving circuit provided by the embodiment of the disclosure. The array substrate can be applied in an LCD (Liquid Crystal Display).

The array substrate includes a pixel driving circuit,

where the pixel driving circuit includes:

a plurality of gate lines and a plurality of data lines, where the plurality of gate lines and the plurality of data lines are arranged in a crossing manner to define a plurality of pixel regions arranged in an array;

a plurality of pixel electrodes, where one pixel electrode is arranged in each pixel region to form an M×N pixel electrode array, M is the number of rows of the pixel electrode array, N is the number of columns of the pixel electrode array, M and N are integers greater than 1, the row direction of the pixel electrode array is the extension direction of the gate line, and the column direction is the extension direction of the data line;

a thin film transistor switch, where at least one thin film transistor switch is arranged in each pixel region, and the pixel electrode is connected to the data line by the thin film transistor switch and configured to input a voltage signal to the pixel electrode by the data line;

where,

the polarities of input voltage signals to two adjacent pixel electrodes are opposite in a same row of pixel electrodes;

M rows of pixel electrodes are divided into Q pixel groups, including a first pixel group, a second pixel group and (Q−2) third pixel groups located between the first pixel group and the second pixel group, where the first pixel group at least includes a first row of pixel electrodes of the pixel electrode array, and the second pixel group at least includes an M^{th} row of pixel electrodes of the pixel electrode array; and each third pixel group includes at least q rows of pixel electrodes, Q is a positive integer greater than 2, and q is a positive integer greater than or equal to 2;

where in the same column of pixel electrodes, the polarities of input voltage signals to the pixel electrodes in the same pixel group are the same, and the polarities of input voltage signals to the pixel electrodes of two adjacent pixel groups are opposite.

Optionally, the first pixel group includes the first row of pixel electrodes, or the first pixel group includes the first row of pixel electrodes and the (q−1) row of pixel electrodes adjacent to the first row of pixel electrodes.

Optionally, the polarities of input voltage signals to two adjacent data lines are opposite.

in the nth column pixel electrode, all the pixel electrodes of one pixel group of any two adjacent pixel groups are connected to an n^{th} data line, all the pixel electrodes of the other pixel group are connected to an (n+1)^{th} data line, and n is a positive integer less than or equal to N.

Optionally, the pixel driving circuit further includes:

a time sequence controller connected with the gate line and configured to drive the pixel electrode array row by row at a first frame rate in a first time period; and driving the pixel electrode array one pixel group by one pixel group at a second frame rate, where the second frame rate is greater than the first frame rate.

Optionally, the second frame rate is q times the first frame rate.

Optionally, q is equal to 2.

Optionally, the first frame rate is 60 Hz, and the second frame rate is 120 Hz.

Optionally, the second pixel group includes the M^{th} row of pixel electrodes, or the second pixel group includes the M^{th} row of pixel electrodes and the (q−1) row of pixel electrodes adjacent to the MI row of pixel electrodes.

Optionally, the first pixel group includes the first row of pixel electrodes, or the first pixel group includes the first row of pixel electrodes and the (q−1) row of pixel electrodes adjacent to the first row of pixel electrodes.

the second pixel group includes the M^{th} row of pixel electrodes, or the second pixel group includes the M^{th} row of pixel electrodes and the (q−1) row of pixel electrodes adjacent to the M^{th} row of pixel electrodes.

According to the array substrate of the embodiment of the disclosure, the pixel driving circuit includes an M N pixel electrode array, where the polarities of input voltage signals to two adjacent pixel electrodes in the same row of pixel electrodes are opposite, the M row of pixel electrodes are divided into Q pixel groups, and in the same column of pixel electrodes, the polarities of input voltage signals to the pixel electrodes in the same pixel group are the same, and the polarity of the input voltage signals to the pixel electrodes of two adjacent pixel groups is opposite. Therefore, during pixel driving, a scanning signal can be input to the gate line through the time sequence controller, each row of pixel electrodes can be opened row by row at a first frame rate, or the pixel electrode array can be opened pixel by pixel group at a second frame rate, so that real-time switching between the first frame rate and the second frame rate is realized. The pixel structure of the pixel driving circuit keeps the characteristic of excellent picture quality, has the power-saving effect of a column overturning mode, can switch between the first frame rate and the second frame rate in real time according to different picture requirements, and enables video to be smoother.

The embodiment of the disclosure also provides a display device including the array substrate provided by the embodiment of the disclosure.

The display device may be: the display device further includes a flexible circuit board, a printed circuit board and a back plate.

According to the display device of the embodiment of the disclosure, the pixel driving circuit includes an M×N pixel electrode array, where the polarities of input voltage signals to two adjacent pixel electrodes in the same row of pixel electrodes are opposite, the M row of pixel electrodes are divided into Q pixel groups, and in the same column of pixel electrodes, the polarities of input voltage signals to the pixel electrodes in the same pixel group are the same, and the polarity of the input voltage signals to the pixel electrodes of two adjacent pixel groups is opposite. Therefore, during pixel driving, a scanning signal can be input to the gate line through the time sequence controller, each row of pixel electrodes can be opened row by row at a first frame rate, or the pixel electrode array can be opened pixel by pixel group at a second frame rate, so that real-time switching between the first frame rate and the second frame rate is realized. The pixel structure of the pixel driving circuit keeps the characteristic of excellent picture quality, has the power-saving effect of a column overturning mode, can switch between the first frame rate and the second frame rate in real time according to different picture requirements, and enables video to be smoother.

In addition, the embodiment of the invention also provides a pixel driving method, which is applied to the pixel driving circuit provided by the embodiment of the invention.

driving the pixel electrode array row by row at a first frame rate in a first time period; and

driving the pixel electrode array one pixel group by one pixel group at a second frame rate in a second time period, where the second frame rate is greater than the first frame rate.

It is obvious that the array substrate, the display device and the pixel driving method provided by the embodiment of the present disclosure can also bring the beneficial effects brought by the pixel driving method provided by the embodiment of the present disclosure, which will not be described in detail.

There are the following points to explain:

(1) The drawings of the embodiments of the present disclosure relate only to the structures related to the embodiments of the present disclosure, and other structures may be referred to in the general design.

(2) For clarity, in the drawings used to describe embodiments of the present disclosure, the thickness of layers or regions is exaggerated or reduced, i.e., the drawings are not drawn to scale. It will be understood that when an element such as a layer, film, region, or substrate is referred to as being “on” or “under” another element, the element may be “directly on” or “under” the other element or intervening elements may be present.

(3) Embodiments of the present disclosure and features in embodiments may be combined with one another to yield new embodiments without conflict. It is intended that the present disclosure be limited only by the specific embodiments disclosed, but that the scope of the disclosure be limited only by the claims appended hereto.

What is claimed is:

1. A pixel driving circuit, comprising:
a plurality of gate lines and a plurality of data lines, wherein the plurality of gate lines and the plurality of data lines are arranged in a crossing manner to define a plurality of pixel regions arranged in an array;
a plurality of pixel electrodes, wherein one pixel electrode is arranged in each pixel region to form an M×N pixel electrode array, M is the number of rows of the pixel electrode array, N is the number of columns of the pixel electrode array, M and N are integers greater than 1, the row direction of the pixel electrode array is the extension direction of the gate line, and the column direction is the extension direction of the data line;
a thin film transistor switch, wherein at least one thin film transistor switch is arranged in each pixel region, and the pixel electrode is connected to the data line by the thin film transistor switch and configured to input a voltage signal to the pixel electrode by the data line;
wherein,
the polarities of input voltage signals to two adjacent pixel electrodes are opposite in a same row of pixel electrodes;
M rows of pixel electrodes are divided into Q pixel groups, comprising a first pixel group, a second pixel group and (Q−2) third pixel groups located between the first pixel group and the second pixel group, wherein the first pixel group at least comprises a first row of pixel electrodes of the pixel electrode array, and the second pixel group at least comprises an M^{th} row of pixel electrodes of the pixel electrode array; and each third pixel group comprises at least q rows of pixel electrodes, Q is a positive integer greater than 2, and q is a positive integer greater than or equal to 2;
wherein in the same column of pixel electrodes, the polarities of input voltage signals to the pixel electrodes in the same pixel group are the same, and the polarities of input voltage signals to the pixel electrodes of two adjacent pixel groups are opposite.

2. The pixel driving circuit according to claim 1, wherein
the first pixel group comprises the first row of pixel electrodes, or the first pixel group comprises the first row of pixel electrodes and a (q−1) row of pixel electrodes adjacent to the first row of pixel electrodes.

3. The pixel drive circuit according to claim 1, wherein
the polarities of input voltage signals to two adjacent data lines are opposite;
in the nth column pixel electrode, all the pixel electrodes of one pixel group of any two adjacent pixel groups are connected to an n^{th} data line, all the pixel electrodes of the other pixel group are connected to an (n+1)^{th} data line, and n is a positive integer less than or equal to N.

4. The pixel driving circuit according to claim 1, further comprising:
a time sequence controller connected with the gate line and configured to drive the pixel electrode array row by row at a first frame rate in a first time period; and driving the pixel electrode array one pixel group by one pixel group at a second frame rate, wherein the second frame rate is greater than the first frame rate.

5. The pixel driving circuit according to claim 4, wherein
the second frame rate is q times the first frame rate.

6. The pixel driving circuit according to claim 5, wherein
q is equal to 2.

7. The pixel driving circuit according to claim 6, wherein
the first frame rate is 60 Hz, and the second frame rate is 120 Hz.

8. The pixel driving circuit according to claim 1, wherein
the second pixel group comprises the M^{th} row of pixel electrodes, or the second pixel group comprises the M^{th} row of pixel electrodes and the (q−1) row of pixel electrodes adjacent to the M^{th} row of pixel electrodes.

9. The pixel driving circuit according to claim 1, wherein
the first pixel group comprises the first row of pixel electrodes, or the first pixel group comprises the first row of pixel electrodes and the (q−1) row of pixel electrodes adjacent to the first row of pixel electrodes;
the second pixel group comprises the M^{th} row of pixel electrodes, or the second pixel group comprises the M^{th} row of pixel electrodes and the (q−1) row of pixel electrodes adjacent to the M^{th} row of pixel electrodes.

10. An array substrate, comprising a pixel driving circuit,
wherein the pixel driving circuit comprises:
a plurality of gate lines and a plurality of data lines, wherein the plurality of gate lines and the plurality of data lines are arranged in a crossing manner to define a plurality of pixel regions arranged in an array;
a plurality of pixel electrodes, wherein one pixel electrode is arranged in each pixel region to form an M×N pixel electrode array, M is the number of rows of the pixel electrode array, N is the number of columns of the pixel electrode array, M and N are integers greater than 1, the row direction of the pixel electrode array is the extension direction of the gate line, and the column direction is the extension direction of the data line;
a thin film transistor switch, wherein at least one thin film transistor switch is arranged in each pixel region, and the pixel electrode is connected to the data line by the thin film transistor switch and configured to input a voltage signal to the pixel electrode by the data line;
wherein,
polarities of input voltage signals to two adjacent pixel electrodes is opposite in a same row of pixel electrodes;
M rows of pixel electrodes are divided into Q pixel groups, comprising a first pixel group, a second pixel group and (Q−2) third pixel groups located between the first pixel group and the second pixel group, wherein the first pixel group at least comprises a first row of pixel electrodes of the pixel electrode array, and the second pixel group at least comprises an M^{th} row of pixel electrodes of the pixel electrode array; and each third pixel group comprises at least q rows of pixel electrodes, Q is a positive integer greater than 2, and q is a positive integer greater than or equal to 2;
wherein in the same column of pixel electrodes, the polarities of input voltage signals to the pixel electrodes in the same pixel group are the same, and the polarities of input voltage signals to the pixel electrodes of two adjacent pixel groups are opposite.

11. The array substrate according to claim 10, wherein
the first pixel group comprises the first row of pixel electrodes, or the first pixel group comprises the first row of pixel electrodes and the (q−1) row of pixel electrodes adjacent to the first row of pixel electrodes.

12. The array substrate according to claim 10, wherein
the polarities of input voltage signals to two adjacent data lines are opposite;
in the nth column pixel electrode, all the pixel electrodes of one pixel group of any two adjacent pixel groups are connected to an n^{th} data line, all the pixel electrodes of the other pixel group are connected to an (n+1)^{th} data line, and n is a positive integer less than or equal to N.

13. The array substrate according to claim 10, further comprising:
a time sequence controller connected with the gate line and configured to drive the pixel electrode array row by row at a first frame rate in a first time period; and driving the pixel electrode array one pixel group by one pixel group at a second frame rate, wherein the second frame rate is greater than the first frame rate.

14. The array substrate according to claim 13, wherein
the second frame rate is q times the first frame rate.

15. The array substrate according to claim 14, wherein
q is equal to 2.

16. The array substrate according to claim 13, wherein
the first frame rate is 60 Hz, and the second frame rate is 120 Hz.

17. The pixel driving circuit according to claim 10, wherein
the second pixel group comprises the M^{th} row of pixel electrodes, or the second pixel group comprises the M^{th} row of pixel electrodes and the (q−1) row of pixel electrodes adjacent to the M^{th} row of pixel electrodes.

18. The pixel driving circuit according to claim 10, wherein
the first pixel group comprises the first row of pixel electrodes, or the first pixel group comprises the first row of pixel electrodes and the (q−1) row of pixel electrodes adjacent to the first row of pixel electrodes;
the second pixel group comprises the M^{th} row of pixel electrodes, or the second pixel group comprises the M^{th} row of pixel electrodes and the (q−1) row of pixel electrodes adjacent to the M^{th} row of pixel electrodes.

19. A display device comprising the array substrate according to claim 10.

20. A pixel driving method applied to the pixel driving circuit according to claim 1, wherein the method comprises:
driving the pixel electrode array row by row at a first frame rate in a first time period; and
driving the pixel electrode array one pixel group by one pixel group at a second frame rate in a second time period, wherein the second frame rate is greater than the first frame rate.
